(19) United States
(12) Patent Application Publication
(10) Pub. No.: US 2001/0012553 A1
(43) Pub. Date: Aug. 9, 2001

(54) End piece for a gliding board

(75) Inventor: Thierry Marion, Duingt (FR)

Correspondence Address: GREENBLUM & BERNSTEIN, 1941 ROLAND CLARKE PLACE, RESTON, VA, 20191

(73) Assignee: SALOMON S.A.

(21) Appl. No.: 09/740,972

(22) Filed: Dec. 21, 2000

(30) Foreign Application Priority Data
Dec. 22, 1999 (FR) 99 16433

(51) Int. Cl. B32B 3/06

(52) U.S. Cl. 428/99; 428/122

(57) ABSTRACT

An assembly including an end-piece adapted to be attached on a gliding board. The end-piece has at least one U-shaped cavity. The cavity has an upper surface, a lower surface, and a bottom that connects the upper surface to the lower surface. The assembly includes at least one clip that occupies a portion of the cavity, the clip having at least one edge that extends along a surface of the cavity, the edge having at least one claw projecting relative to the edge, away from the surface along which the edge extends.

### BACKGROUND OF THE INVENTION

1. Field of the Invention

The present invention relates to the field of end-pieces for gliding boards, and relates more particularly to an assembly including an end-piece for a board adapted to snowboarding.

2. Description of Background and Relevant Information

A snowboarder must use his/her board essentially under two conditions.

The first condition relates to the operation or use of the board on the snow, and the second condition relates to transporting the board. Under both conditions, the edges of the board are subject to impacts, especially at the tips of the board.

During operation, the board can, for example, strike a rock beneath the snow.

During transportation, the board can strike a surface such as the floor of a cable car.

An impact can cause damage such as irreversible deformations, incipient fractures, cracks, or the like. As a result, the board becomes difficult to use, and even unusable.

In the prior art solutions have been proposed for protecting the board edges, especially at the tips.

For example, it is known to affix a grooved end-piece at the tip of a board. In this case, the tip of the board is housed in the groove, the end-piece forming a projection above and beneath the board. The end-piece is affixed to the board, for example, by means of glue. This protective means is efficient. However, the end-piece itself is irremovable because of the glue. Therefore, it is difficult to replace a damaged end-piece.

To remedy this disadvantage, removable end-pieces fixed mechanically to the board have been proposed.

For example, an end-piece according to the document DE-U1-297 02 084 is held on the board by a nesting device having complementary shapes. This device requires obtaining special recesses in the board. As a result, the board is complex and expensive to produce, and the end-piece can only be used on a board that is shaped to receive the end-piece.

Another example of end-piece, according to the document WO 97/16225 is held on the board by pinching, i.e., by means of a force-fit. A groove of the end-piece, which has a pinched shape, receives the tip of the board. The retaining force created by the pinched shape is not sufficient to retain the end-piece on the board under all conditions of use.

### SUMMARY OF THE INVENTION

An object of the invention is especially a removable assembly including an end-piece that can be affixed to a board without it being necessary to provide the board with a special configuration, and which remains affixed to the board under all conditions of use.

To this end, an assembly according to the invention includes an end-piece provided to be attached on a gliding board, the end-piece having at least one generally U-shaped cavity, the cavity having an upper surface provided to be located above a portion of the top surface of the board, a lower surface provided to be located beneath a portion of the bottom surface of the board, and a bottom that connects the upper surface to the lower surface of the cavity.

The assembly according to the invention includes at least one clip retained in the cavity by a retaining arrangement, the clip having at least one edge that extends along a surface of the cavity, the edge having at least one claw projecting relative to the edge, away from the surface along which the edge extends.

Each claw of an edge is provided to penetrate into the top surface or bottom surface of the board. This means that when a tip of the board penetrates into a cavity of the end-piece, each claw creates a recess in the board in which to house itself.

The association of a claw and of a recess enables an obstacle or positive coupling of the end-piece with respect to the board. This coupling is removable, but has the advantage of retaining the end-piece on the board under all conditions of use.

Moreover, the end-piece can be affixed to a board without it being necessary to provide the board with a special configuration.

### BRIEF DESCRIPTION OF DRAWINGS

Other characteristics and advantages of the invention will be better understood from the description that follows, with reference to the annexed drawings showing, by way of non-limiting example, how the invention can be embodied, and in which:

FIG. 1. is a perspective view of a board provided with two assemblies according to the invention;

FIG. 2 is a cross-section along the line II-II of FIG. 1;

FIG. 3 is a perspective view of an element of FIG. 1;

FIG. 4 is a perspective view of an element of FIG. 3; and

FIG. 5 is a cross-section along the line V-V of FIG. 1.

### DETAILED DESCRIPTION OF THE INVENTION

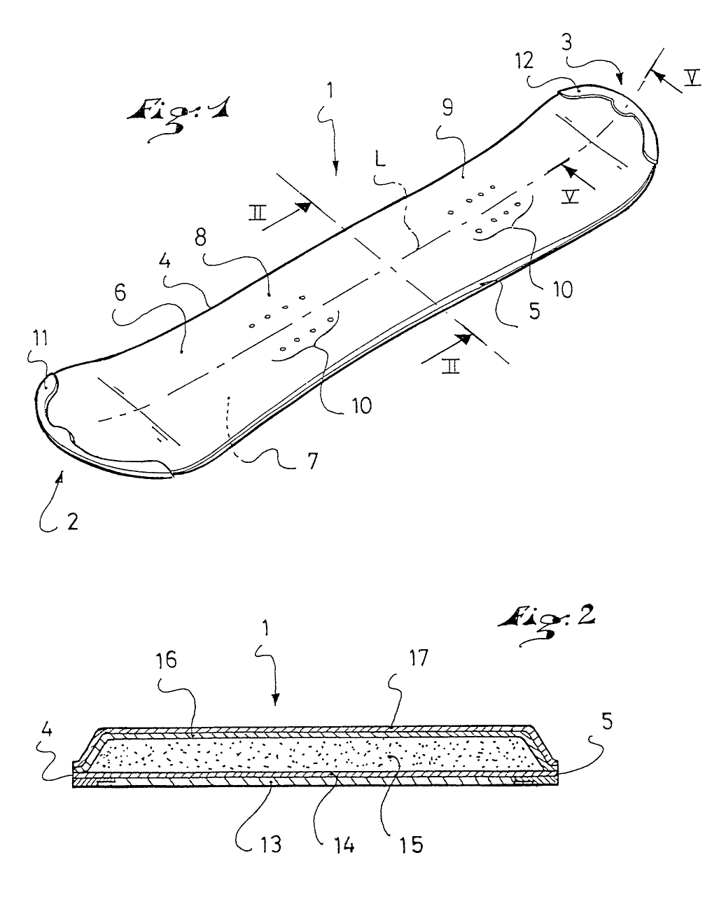

In a known manner, as seen in FIG. 1, a board 1 has a length measured along a longitudinal direction L, between a first tip 2 and a second tip 3. The board 1 also has a width measured between a first lateral edge 4 and a second lateral edge 5, as well as a thickness measured between a top surface 6 and a bottom surface or gliding surface 7.

Both of the user's feet are retained on the board 1, in a first retaining zone 8 and in a second retaining zone 9, respectively.

An affixing arrangement shown in the form of threaded holes 10 make it possible to affix the board 1 to devices for retaining the user's boots. For reasons of convenience, the devices and the boots are not shown.

A first end-piece 11 is affixed to the board 1 at the first tip 2, and a second end-piece 12 is affixed to the board 1 at the second tip 3, as explained below.

The thickness of the board 1 is structured as shown in FIG. 2.

The thickness of the board 1 is a superposition of a bottom layer or gliding sole 13, a lower reinforcement 14, a core 15, an upper reinforcement 16, and a top layer or protective layer 17.

The gliding sole is preferably made of a plastic material containing polyethylene. The protective layer is preferably made of a plastic material containing acetyl-butadiene-styrene. Each of the lower 14 and upper 16 reinforcements is made of resin-impregnated fiber fabrics. The fibers can be glass, carbon, aramid, metal, or the like.

The core can be made of wood, a foam from a plastic material such as polyethylene, or any equivalent material.

The constituent elements of the board 1 are affixed by an increase in pressure and temperature in a mold.

Next, the end-pieces 11, 12 are attached on the board 1.

Only one of the end-pieces is described hereinafter because they are similar.

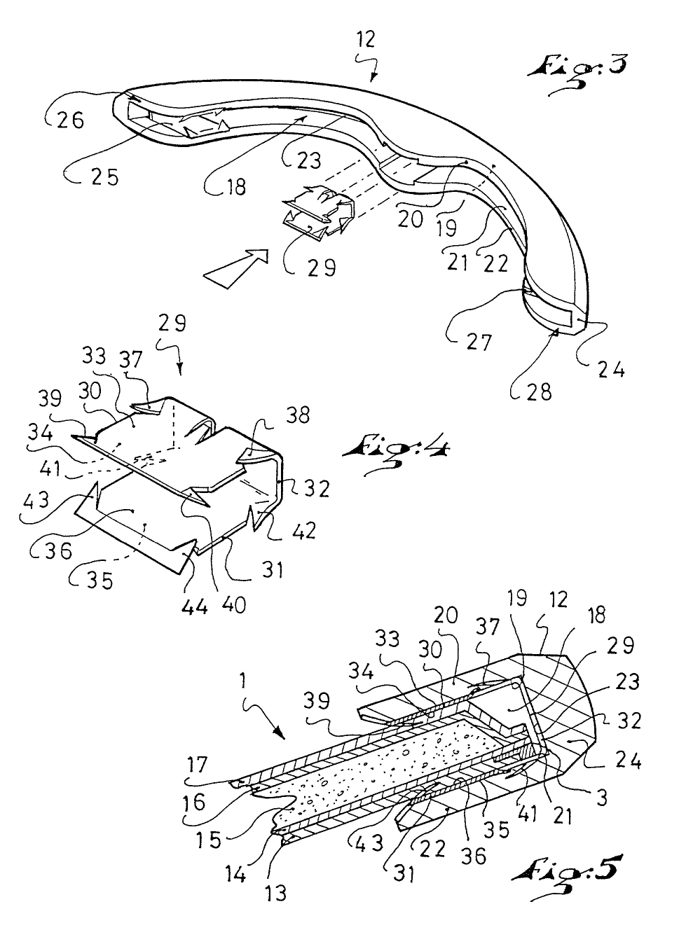

For example, the second end-piece 12, shown in FIG. 3, has a crescent-like generally incurved shape. The end-piece 12 has a U-shaped cavity 18 open toward the center(s) of curvature of the end-piece 12. The cavity 18 is demarcated by an upper surface 19 of an upper edge 20, by a lower surface 21 of a lower edge 22, and by a bottom 23 of a wall 24 that connects the upper 20 and lower 22 edges to one another. The upper 19 and lower 21 surfaces are therefore opposite one another. The upper 20 and lower 22 edges are substantially parallel to one another, and have substantially the same thickness.

Each of the end-pieces 11, 12 is preferably made of a plastic material such as polyethylene, polyurethane, acetyl-butadiene-styrene, or the like.

Such a material has the advantage of absorbing at least a portion of the energy associated with an impact. Another advantage of this type of material is that it provides the end-piece with a flexibility that enables it to adapt to the shape of a tip of a board, even if the curvature of the board is not identical to the curvature of the end-piece. Thus, when the end-piece is on the board, the wall 24 conforms to the shape of the tip of the board.

According to the invention, three clips are provided to affix the end-piece 12 to the board 1.

A first clip 25 is located in the vicinity of a first end 26 of the end-piece 12, a second clip 27 is located in the vicinity of a second end 28 of the end-piece 12, and a central clip 29 is located substantially half-way between the ends 26, 28.

The clips 25, 27, 29 are preferably identical, so as to lower the production costs. For this reason, only one of them will be described hereinafter.

Each clip is provided to be inserted in the cavity 18 of the end-piece 12, as shown by the arrow in the case of the central clip 29.

This clip is shown in FIG. 4. It is U-shaped like the cavity 18.

The clip 29 has an upper edge 30 that is connected to a lower edge 31 by a wall 32.

The upper edge 30 has an outer surface 33 provided to face the upper surface 19 of the cavity 18, as well as an inner surface 34 provided to face the top surface 6 of the board 1.

By analogy, the lower edge 31 has an outer surface 35 provided to face the lower surface 21 of the cavity 18, as well as an inner surface 36 provided to face the gliding surface 7 of the board 1. The inner surfaces 34, 36 of the clip 29 are opposite one another.

Each of the edges 30, 31 of the clip 29 has claws, i.e., portions that project relative to a surface of the edge.

The upper edge 30 has two claws 37, 38 projecting with respect to the outer surface 33, as well as two claws 39, 40 projecting with respect to the inner surface 34.

By analogy, the lower edge 31 has two claws 41, 42 projecting with respect to the outer surface 35, as well as two claws 43, 44 projecting with respect to the inner surface 36.

The clip 29 is an integral piece, such as unitary, made preferably of a metal or a metallic alloy, such as a spring steel, an alloy containing aluminum and silicium, or the like.

The clip 29 can be made by stamping, then bending a plate. In this case, a first punch makes it possible to configure the claws that project relative to a first surface of the plate. A second punch makes it possible to configure the claws that project relative to a second surface of the plate, opposite the first with respect to the thickness of the plate. A third punch provides the clip 29 with its dimensions in the unfolded state. Finally, a bending provides the clip with its final U-shape. A heat treatment can be provided after bending, especially to increase the bending strength of the constituent material of the clip 29. Thus, the claws oppose a strong folding resistance and tend to remain in projection with respect to the surfaces of the edges of the clip.

The clip 29 enables the end-piece 12 to be retained on the board 1, as can be seen in cross-section in FIG. 5.

The claws projecting relative to an outer surface 33, 35 of an edge 30, 31 of the clip 29 retain the end-piece on the clip, and the claws projecting relative to an inner surface 34, 36 of an edge 30, 31 of the clip 29 retain the clip on the board 1.

The retention of the end-piece 12 means that it is prevented from moving away from the tip 3 of the board 1 when the latter is used, i.e., during operation or transportation.

For reasons of convenience, only one of the claws that fulfill the same function is described. This corresponds to two cases.

The first case is that of the claws that retain the end-piece on the clip. These claws are designated by the reference numerals 37, 38, 41, 42. The claw 37, which projects with respect to the outer surface 33 of the edge 30 of the clip 29, has a pointed shape directed both away from the outer surface 33 and away from the wall 32.

It could also be said that the claw 37 projects with respect to the edge 30 toward the surface 19 along which the edge 30 extends.

After it has been inserted in the cavity 18 of the end-piece 12, the clip 29 remains in place in the cavity because the claws, such as the claw 37, prevent the clip 29 from coming out. This means that the claws prevent the wall 32 of the clip 29 from moving away from the wall 24 of the end-piece 12.

Indeed, each claw 37, 38, 41, 42 penetrates into the constituent material of the end-piece 12 after the clip has been positioned. This phenomenon occurs because each claw is harder than the material of the end-piece, which, in conjunction with its shape, causes the claw to penetrate into the end-piece.

The second case is that of the claws that retain the clip on the board. These claws are designated by the reference numerals 39, 40, 43, 44.

The claw 39, which projects relative to the inner surface 34 of the edge 30 of the clip 29, has a pointed shape directed both away from the inner surface 34 and toward the wall 32.

After it has been inserted on the tip 3 of the board 1, the clip 29 remains in place on the board because the claws, such as the claw 39, prevent the clip 29 from moving away from the tip 3 of the board 1.

In a manner similar to the first case, the claws 39, 40, 43, 44 penetrate into the board, because each claw is harder than the protective layer 17 or the sole 13.

The mounting of the end-piece on the board is carried out preferably according to the following process. An assembly is formed by introducing the clips 25, 27, 29 into the cavity 18 of the end-piece 12. Next, this assembly is attached on the board 1 by introducing the tip 3 of the board into the cavity of the end-piece.

The claws have a resistance that is sufficient to retain the end-piece during operation of the board, or during transportation.

However, it is possible to replace the end-piece. For example, the use of a wooden wedge or of a mallet makes it possible to apply a shock on the end-piece, away from the tip of the board. If the shock is localized where a clip is, the latter moves with the end-piece and enables the assembly to be dismounted.

The mounting can be carried out manually or automatically, i.e., by means of assembling machines.

The invention is not limited to the specific details of the exemplary embodiment described hereinabove, but includes all of the technical equivalents that fall within the scope of the claims that follow.

In particular, a different number of clips can be provided.

Each clip can have a different number of claws.

The claws could have a different shape, for example that of a larger blade.

Still further, a clip could have a different shape or include a different number of edges.

For example, it could be provided to place a single edge either on the side of the top surface 6 of the board 1, or on the side of the gliding surface 7. In this case, the edge can include claws on each surface. But the edge can also include claws only on the side provided to contact the board, the other side being affixed to the end-piece by a retaining means such as adhesive, duplicate molding, nesting.

This means, in a broad sense, that the clip must be understood as being a piece that includes at least one edge that extends along a surface of the cavity of the end-piece, the edge having at least one claw that projects with respect to the edge, away from the surface along which the edge extends.

In the extreme, a clip could be formed by a single edge.

The instant application is based upon French Patent Application No. 99 16433, filed Dec. 22, 1999, the disclosure of which is hereby incorporated by reference thereto in its entirety, and the priority of which is hereby claimed under 35 U.S.C. §119.

What is claimed is:

1. An end-piece assembly adapted to be attached to a gliding board, said assembly comprising:
an end-piece having at least one generally U-shaped cavity, the cavity having an upper surface adapted to be located above a portion of a top surface of the board, a lower surface adapted to be located beneath a portion of a bottom surface of the board, and a bottom that connects the upper surface to the lower surface of the cavity; and
at least one clip retained in the cavity by a retaining arrangement, said clip having at least one edge that extends along a surface of the cavity, the edge having at least one claw that projects relative to the edge, away from the surface along which the edge extends.

2. An assembly according to claim 1, wherein the arrangement for retaining the clip in the cavity comprises at least one claw presented by the edge, the claw projecting relative to the edge, toward the surface along which the edge extends.

3. An assembly according to claim 2, wherein the clip is U-shaped, the shape being obtained by the association of an upper edge with a lower edge by a wall, each edge having an outer surface and an inner surface, the inner surfaces facing one another.

4. An assembly according to claim 3, wherein each claw has a pointed shape, the claws that project with respect to an outer surface being directed both away from the outer surface and away from the wall, the claws that project with respect to an inner surface being directed both away from the inner surface and toward the wall.

5. An assembly according to claim 1, wherein the assembly includes three clips.

6. An assembly according to claim 1, wherein the end-piece has a crescent-like generally incurved shape.

7. An assembly according to claim 1, wherein the end-piece is made of plastic, and wherein each clip is made of steel.

8. A process for affixing a protective assembly to a gliding board, said process comprising:
obtaining an end-piece having a U-shaped cavity;
obtaining at least one U-shaped clip;
arranging each clip in the cavity;
introducing a tip of the board into the cavity.
